(19) United States
(12) Patent Application Publication
(10) Pub. No.: US 2015/0363372 A1
(43) Pub. Date: Dec. 17, 2015

(54) METHOD AND DEVICE FOR UPDATING USER DATA

(71) Applicant: Xiaomi Inc., Beijing (CN)

(72) Inventor: Lei Zhang, Beijing (CN)

(73) Assignee: Xiaomi Inc.

(21) Appl. No.: 14/617,133

(22) Filed: Feb. 9, 2015

Related U.S. Application Data
(63) Continuation of application No. PCT/CN2014/091745, filed on Nov. 20, 2014.

(30) Foreign Application Priority Data
Jun. 12, 2014 (CN) 201410260916.0

(51) Int. Cl. G06F 17/22; G06F 17/24

(52) U.S. Cl. CPC G06F 17/2288; G06F 17/24

(57) ABSTRACT

A method for updating user data after an electronic publication is revised, includes: acquiring, in the electronic publication before the revision, an original character string, according to a quoted content in user data associated with the electronic publication before the revision; matching the original character string in the revised electronic publication; and when the matching is successful, updating the quoted content in the user data according to the matching result, to obtain updated user data.

### CROSS-REFERENCE TO RELATED APPLICATIONS

The present application is a continuation of International Application No. PCT/CN2014/091745, filed Nov. 20, 2014, which is based upon and claims priority to Chinese Patent Application No. 201410260916.0, filed Jun. 12, 2014, the entire contents of all of which are incorporated herein by reference.

### TECHNICAL FIELD

The present disclosure generally relates to the field of electronic publication and, more particularly, to a method and a device for updating user data.

### BACKGROUND

Electronic publications are increasingly popular due to their short revision cycles and low revision costs. When reading electronic publications, users may generate user data in types of bookmarks, annotations and digests. The user data may include quoted contents and user reading information regarding the quoted contents.

The quoted contents in user data are generally represented by physical offsets in an electronic publication. When the electronic publication is revised, the quoted contents may also be changed. Conventionally, detailed revision records of every version are recorded in manners similar to patch files, and the quoted contents are recalculated based on the revision records. However, because patch files take significant computation resources to generate and need to be maintained separately, they are not suitable for wide usage.

### SUMMARY

According to a first aspect of the present disclosure, there is provided a method for updating user data after an electronic publication is revised, comprising: acquiring, in the electronic publication before the revision, an original character string, according to a quoted content in user data associated with the electronic publication before the revision; matching the original character string in the revised electronic publication; and when the matching is successful, updating the quoted content in the user data according to the matching result, to obtain updated user data.

According to a second aspect of the present disclosure, there is provided a device for updating user data after an electronic publication is revised, comprising: a processor; a memory for storing instructions executable by the processor; wherein the processor is configured to: acquire, in the electronic publication before the revision, an original character string, according to a quoted content in user data associated with the electronic publication before the revision; match the original character string in the revised electronic publication; and when the matching is successful, update the quoted content in the user data according to the matching result, to obtain updated user data.

According to a third aspect of the present disclosure, there is provided a non-transitory computer-readable storage medium storing instructions that, when executed by a processor of a device, cause the device to perform a method for updating user data after an electronic publication is revised, the method comprising: acquiring, in the electronic publication before the revision, an original character string, according to a quoted content in user data electronic publication before the revision; matching the original character string in the revised electronic publication; and when the matching is successful, updating the quoted content in the user data according to the matching result, to obtain updated user data.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram illustrating an implementation environment of a method for updating user data, according to exemplary embodiments.

FIG. 2 is a flowchart of a method for updating user data, according to an exemplary embodiment.

FIG. 3A is a flowchart of a method for updating user data, according to an exemplary embodiment.

FIG. 3B is a schematic diagram illustrating a chapter in an electronic publication before and after the electronic publication is revised, according to an exemplary embodiment.

FIG. 4A is a flowchart of a method for updating user data, according to an exemplary embodiment.

FIG. 4B is a schematic diagram illustrating a chapter in an electronic publication before and after the electronic publication is revised, according to an exemplary embodiment.

FIG. 5A is a flowchart of a method for updating user data, according to an exemplary embodiment.

FIG. 5B is a schematic diagram illustrating a chapter in an electronic publication before and after the electronic publication is revised, according to an exemplary embodiment.

FIG. 6 is a block diagram of a device for updating user data, according to an exemplary embodiment.

FIG. 7 is a block diagram of a device for updating user data, according to an exemplary embodiment.

FIG. 8 is a block diagram of a device for updating user data, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects associated with the invention as recited in the appended claims.

In exemplary embodiments, user data may be generated when a user reads an electronic publication. The user data may include quoted contents and user reading information regarding the quoted contents. The user data may be in the type of a bookmark, a digest, or an annotation.

For example, a bookmark may be expressed as “the 120,305th character, the 3rd bookmark.” “The 120,305th character” is the quoted content, used for indicating that a user's reading has arrived at a position of the 120,305th character last time. “The 3rd bookmark” is the user reading information, used for indicating that this is the 3rd bookmark in the book.

Also for example, a digest may be expressed as “the 120,305th character, total of 32 characters, the 1st digest.” The quoted content, “the 120,305th character, total of 32 characters,” is used for indicating that the quoted content starts from the position of the 120,305th character and has a length of 32 characters. The user reading information, “the 1st digest,” is used for indicating that this is the 1st digest in the book. Alternatively, the quoted content may be expressed as “the 120,305th character, the 120,337th character”, indicating that the quoted content starts from the position of the 120,305th character and ends at the position of the 120,337th character.

As another example, an annotation may be “the 120,305th character, total of 32 characters, this paragraph writes so well.” The quoted content, “the 120,305th character, total of 32 characters,” is used for indicating that the quoted content, for which this annotation is created, starts from the position of the 120,305th character and has a length of 32 characters. The user reading information, “this paragraph writes so well,” is the annotation content created by the user for the quoted content. Alternatively, the quoted content may be represented as “the 120,305th character, the 120,337th character”, indicating that the quoted content starts from the position of the 120,305th character and ends at the position of the 120,337th character.

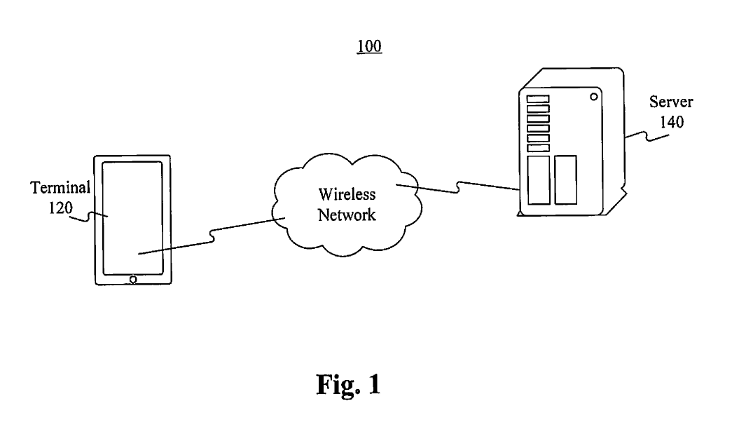

FIG. 1 is a schematic diagram illustrating an implementation environment 100 of a method for updating user data, according to exemplary embodiments. The implementation environment 100 includes at least one terminal 120 and at least one server 140.

The terminal 120 may be electronic equipment having a reading function, such as a smart phone, a tablet PC, a smart TV, an e-book reader, and so on. It may be connected with the server 140 through a wireless network.

The server 140 may be a server, a server cluster consisting of a number of servers, or a cloud computing service center. The server 140 is configured to provide user-data updating service to the terminal 120.

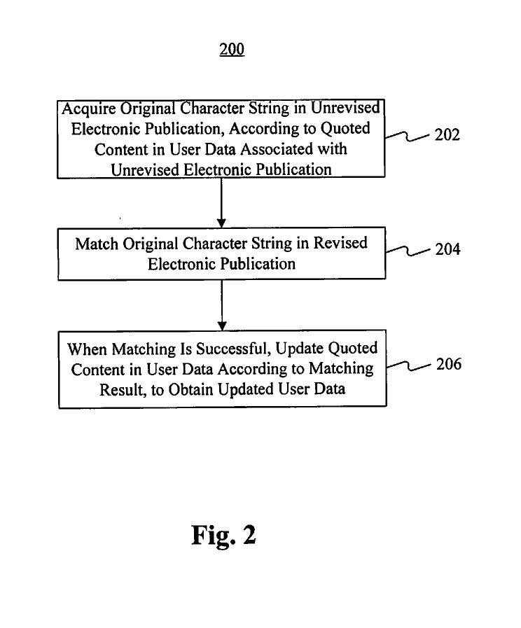

FIG. 2 is a flowchart of a method 200 for updating user data, according to an exemplary embodiment. For example, the method 200 may be applied in a terminal, such as the terminal 120 (FIG. 1). When an electronic publication is revised, the terminal can update user data associated with the electronic publication as well. Referring to FIG. 2, the method 200 includes the following steps.

In step 202, the terminal acquires, in the electronic publication before revision, referred to herein as the unrevised electronic publication, an original character string, according to a quoted content in user data associated with the unrevised electronic publication.

In step 204, the terminal matches the original character string in the revised electronic publication.

In step 206, when the matching is successful, the terminal updates the quoted content in the user data according to the matching result, to obtain updated user data.

The method 200 saves computation costs for generating patch files, and generally does not need separate maintenance. Thus, the method 200 may be applied in a large scale.

In exemplary embodiments, the above step 204 may be implemented in first, second, and third manners.

The first manner is direct matching. The original character string is matched directly in the revised electronic publication.

The second manner is sentence-segmentation matching. The original character string is first segmented into n sentence segments arranged in order. n is a positive integer. Then the n sentence segments are sequentially matched in the revised electronic publication.

The third manner is a combination of direct matching and sentence-segmentation matching. The original character string is first matched directly in the electronic publication after revision. When the direct matching is unsuccessful, the original character string is segmented into n sentence segments arranged in order. n is a positive integer. Then the n sentence segments are sequentially matched in the electronic publication.

The above three implementation manners are further described in three different embodiments below.

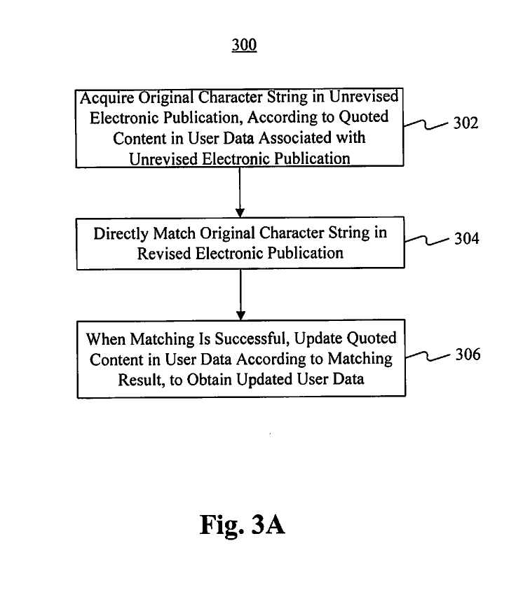

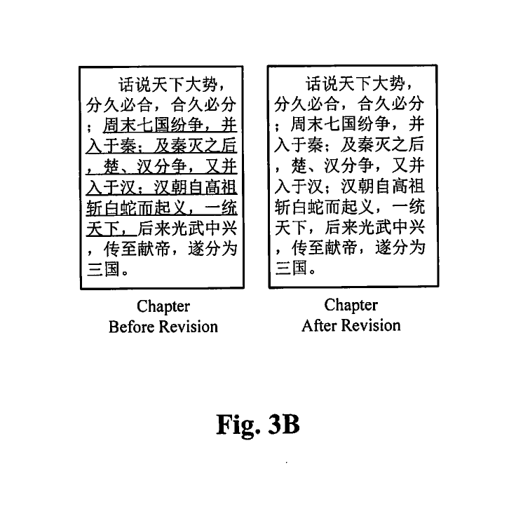

FIG. 3A is a flowchart of a method 300 for updating user data, according to an exemplary embodiment. For example, the method 300 may be applied in a terminal, such as the terminal 120 (FIG. 1). Referring to FIG. 3A, the method 300 includes the following steps.

In step 302, the terminal acquires, in the electronic publication before revision, referred to herein as the unrevised electronic publication, an original character string, according to a quoted content in user data associated with the unrevised electronic publication. The user data may be, e.g., a bookmark, a digest, or an annotation.

In exemplary embodiments, the terminal may use first and second ways to acquire the original character string according to the quoted content.

In the first way, the terminal acquires the original character string according to a start position and a length of the quoted content. For example, when the quoted content is “the 120,305th character, total of 32 characters,” the terminal acquires a character string of 32 characters, staring from the position of the 120,305th character in a current chapter of the unrevised electronic publication.

In the second way, the terminal acquires the original character string according to a start position and an end position of the quoted content. For example, when the quoted content is “the 120,305th character, the 120,337th character”, the terminal acquires a character string from the position of the 120,305th character to the position of the 120,337th character in a current chapter of the unrevised electronic publication.

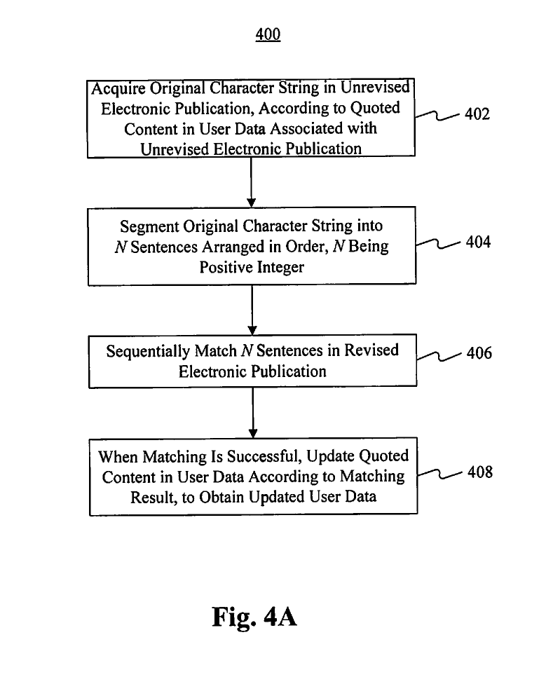

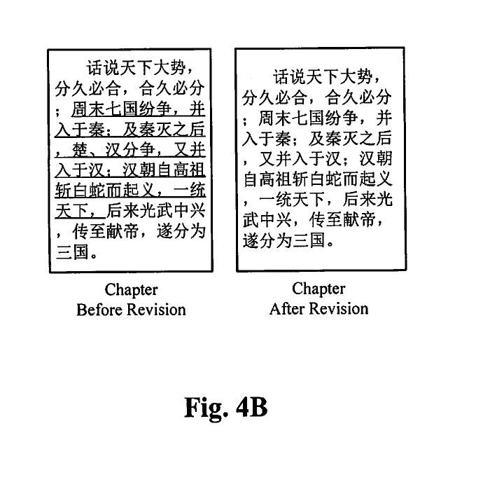

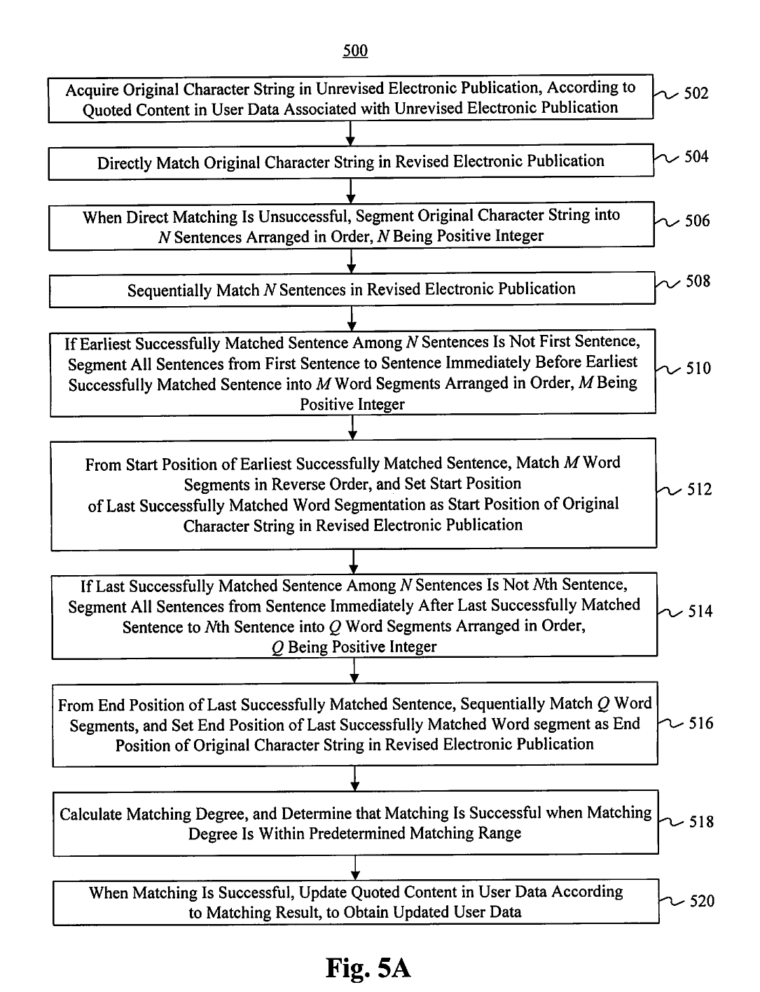

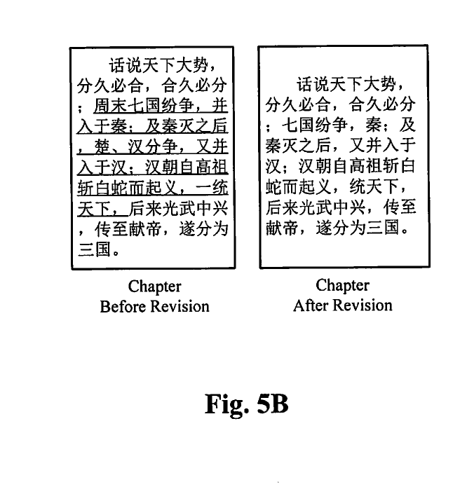

FIG. 3B is a schematic diagram illustrating a chapter in a Chinese electronic publication before and after the electronic publication is revised, according to an exemplary embodiment. Referring to the “Chapter Before Revision” in FIG. 3B, the original Chinese character string acquired by the terminal is “ [symbol] , [symbol] , [symbol] , [symbol] , [symbol] , [symbol] ; [symbol] [symbol] [symbol] , [symbol] ,” (the English translation being: “When the rule of the Zhou Dynasty weakened, seven contending kingdoms sprang up, warring one with another until the kingdom of Qin prevailed and possessed the empire; but when Qin's destiny had been fulfilled, arose two opposing kingdoms, Chu and Han, to fight for the mastery, and Han was the victor; the rise of the fortunes of Han began when Liu Bang the supreme Ancestor slew a white serpent to raise the banners of uprising, which only ended when the whole empire belonged to Han.”) Although the example chapters illustrated in FIG. 3B, and also FIGS. 4B and 5B below, are in Chinese, the described methods are not so limited, and can be used to any language.

In step 304, the terminal directly matches the original character string in the revised electronic publication.

In the revised electronic publication, the terminal starts from the start position of the chapter where the original character is matched, and searches for the original character string, using the length of the string as a searching length. This way, the terminal may match the original character string in the revised electronic publication.

Referring to FIG. 3B, the terminal, starting from the start position, “ [symbol] ,” of the chapter in the revised electronic publication, searches for the original character string, using the length of the string as the searching length. The terminal may find the Chinese character string, “ [symbol] , [symbol] , [symbol] , [symbol] , [symbol] , [symbol] [symbol] , [symbol] ,” in the revised electronic publication, thereby matching the original Chinese character string successfully.

In step 306, when the matching is successful, the terminal updates the quoted content in the user data according to a matching result, to obtain updated user data.

In the present embodiment, the terminal may update the quoted content of the user data according to the position information of the matched character string. The position information may be the start position and the end position of the matched character string in the revised electronic publication. Alternatively, the position information may be the start position and the length of the matched character string in the revised electronic publication.

For example, if the user data is a bookmark, the terminal adds the bookmark at a corresponding position in the revised electronic publication according to the position of the bookmark. If the user data is a digest, the terminal adds the digest at a corresponding position in the revised electronic publication according to the start position and the quoted content of the digest. If the user data is an annotation, the terminal adds the annotation at a corresponding position in the revised electronic publication according to the start position of the annotation, the quoted content, and the contents of the annotation.

Referring to FIG. 3B, the terminal may successfully match the original Chinese character string, “ [symbol] , [symbol] , [symbol] , [symbol] , [symbol] ; [symbol] [symbol] , [symbol] ,”. The user data associated with the original Chinese character string in the revised electronic publication is, e.g., “the 120,305th character, total of 32 characters, the 1st digest.” The terminal may update the user data associated with the revised electronic publication according to the start position of the Chinese character string and the contents of the Chinese character string, and generate updated user data.

The direct matching described in the method 300 is applicable in a situation where the original character string is not changed. For a situation where the original character string is changed, the following embodiments may be used.

FIG. 4A is a flowchart of a method 400 for updating user data, according to an exemplary embodiment. For example, the method 400 may be applied in a terminal, such as the terminal 120 (FIG. 1). Referring to FIG. 4A, the method 400 includes the following steps.

In step 402, the terminal acquires, in an electronic publication before revision, referred to herein as the unrevised electronic publication, an original character string, according to a quoted content in user data associated with the unrevised electronic publication, similar to the above-described step 202 (FIG. 2) and step 302 (FIG. 3A).

In step 404, the terminal segments the original character string into n segments, such as n sentence segments, arranged in order, n being a positive integer. For example, a sentence segment can be a sentence or a part of a sentence. In the present embodiment, it is assumed that each sentence segment is a sentence.

FIG. 4B is a schematic diagram illustrating a chapter in a Chinese electronic publication before and after the electronic publication is revised, according to an exemplary embodiment. Referring to the “Chapter Before Revision” in FIG. 4B, the original Chinese character string acquired by the terminal is “ [symbol] , [symbol] ; [symbol] , [symbol] [symbol] , [symbol] ; [symbol] [symbol] , [symbol] ,”. The terminal segments the original Chinese character string into the following seven sentences: (1) “ [symbol] [symbol] ,”, (2) “ [symbol] ;”, (3) “ [symbol] ,”, (4) “ [symbol] ,”, (5) “ [symbol] [symbol] ;”, (6) “ [symbol] [symbol] ,”, (7)“ [symbol] ,”.

In step 406, the terminal sequentially matches the n sentences in the revised electronic publication.

In the revised electronic publication, the terminal matches an ith sentence from a searching start position, where 1≦i≦n. When i=1, the searching start position is the start position of the chapter where the original character string is matched. When the matching of the ith sentence is successful, the terminal updates the searching start position to be the end position of the ith sentence, and matches the (i+1)th sentence from the updated searching start position, where i+1≦n. When the matching of the ith sentence is unsuccessful, the terminal matches the (i+1)th sentence still from the searching start position of the ith sentence.

Upon the completion of matching all the n sentences, if the matched contents completely match the n sentences, or if the matched contents partially match the n sentences but have a matching degree within a predetermined matching range, the terminal determines that the matching of the original character string is successful. The predetermined matching range measures the accuracy of the matching, for the purposes of preventing similar but incomplete character string being matched and preventing similar but overlong character string being matched. The predetermined matching range may be expressed by the formula: 80% Len1≦Len2≦120% Len1, where Len1 is the length of the original character string, Len2 is the length of the matched character string.

Referring to FIG. 4B, the terminal takes the start position, “ [symbol] ”, of the chapter in the revised electronic publication as the searching start position, and sequentially matches the above-described seven sentences in the chapter. First, the terminal starts from the start position, “ [symbol] ”, and searches for the 1st sentence in the chapter of the revised electronic publication, using the length of the 1st sentence as the searching length. The terminal finds the 1st sentence, and thus matches the 1st sentence successfully. The terminal then updates the searching start position to be the end position, “,”, of the 1st sentence. Next, the terminal starts from the end position, “,”, of the 1st sentence, and searches for the 2^{nd} sentence in the corresponding chapter after revision, using the length of the 2nd sentence as the searching length. The terminal finds the 2nd sentence, and thus also matches the 2nd sentence successfully. The terminal updates the searching start position to be the end position “;” of the 2nd sentence. Subsequently, starting from the end position, “;”, of the 2nd sentence, the terminal searches for the 3rd sentence, and match it successfully. The terminal updates the searching start position to be the end position, “,”, of the 3rd sentence. Then, starting from the end position “,” of the 3rd sentence, and using the length of the 4th sentence as the searching length, the terminal searches the 4th sentence. However, until reaching the end position, “ [symbol] ”, of the chapter, the terminal cannot find the 4th sentence. Thus, the terminal matches the 4th sentence unsuccessfully. In this case, the terminal does not update the searching start position, but continues to search for the 5th sentence from the end position, “,”, of the 3rd sentence, using the length of the 5th sentence as the searching length. The terminal can find the 5th sentence, and thus match the 5th sentence successfully. Similarly, the terminal matches the 6th and 7th sentences successfully. Once the matching of the 7th sentence is completed, the matching of the original character string is ended.

Because the matching of the 4th sentence is unsuccessful, the original character string is partially matched. Consequently, the terminal calculates a relationship between the length of the matched Chinese character string, “ [symbol] , [symbol] ; [symbol] , [symbol] ; [symbol] [symbol] , [symbol] ,”, and the length of the original Chinese character string, “ [symbol] , [symbol] ; [symbol] , [symbol] , [symbol] [symbol] ; [symbol] [symbol] , [symbol] ,”. The length of the original Chinese character string is 47 and the length of the matched Chinese character string is 41. 80% and 120% of the length of the original Chinese character string are 37.5 and 56.4, respectively. Because 37.5<41<56.4, the matching of the original Chinese character string is successful.

In the above example, if the length of the matched Chinese character string is more than 56.4 or less than 37.5, then the matching is considered unsuccessful.

In step 408, when the matching is successful, the terminal updates the quoted content in the user data according to a matching result, to obtain updated user data, similar to the above-described step 206 (FIG. 2) and step 306 (FIG. 3A).

The method 400, by including sentence-segmentation matching, can be used in situations where the original character string changes at, e.g., a sentence level. Moreover, the method 400 determines whether to update user data by comparing the matching degree and a predetermined matching range, thereby improving the accuracy of the updated user data.

FIG. 5A is a flowchart of a method 500 for updating user data, according to an exemplary embodiment. For example, the method 500 may be applied in a terminal, such as the terminal 120 (FIG. 1). Referring to FIG. 5A, the method 500 includes the following steps.

In step 502, the terminal acquires, in an electronic publication before revision, referred to herein as the unrevised electronic publication, an original character string, according to a quoted content in user data associated with the unrevised electronic publication. Step 502 is similar to the above-described step 202 (FIG. 2), step 302 (FIG. 3A), and step 402 (FIG. 4A).

In step 504, the terminal matches the original character string directly in the revised electronic publication, similar to step 304 (FIG. 3A).

FIG. 5B is a schematic diagram illustrating a chapter in a Chinese electronic publication before and after the electronic publication is revised, according to an exemplary embodiment. Referring to FIG. 5B, the original Chinese character string acquired by the terminal is “ [symbol] , [symbol] ; [symbol] , [symbol] , [symbol] ; [symbol] [symbol] [symbol] , [symbol] ,”. According to the present embodiment, the terminal starts from the start position, “ [symbol] ”, of the chapter in the revised electronic publication, and searches for the original Chinese character string until reaching the end position, “ [symbol] ”, of the chapter, using the length of the original Chinese character string as the searching length. However, the terminal dose not find the original Chinese character string. Consequently, the direct matching of the original Chinese character string fails.

In step 506, when the direct matching is not successful, the terminal segments the original character string into n segments, e.g., n sentence segments, arranged in order, n being a positive integer. For example, a sentence segment can be a sentence or a part of a sentence. In the present embodiment, it is assumed that each sentence segment is a sentence. Step 506 is similar to the step 404 (FIG. 4A).

Referring to the “Chapter Before Revision” in FIG. 5B, the original Chinese character string may be segmented into the same seven sentences as in FIG. 4B, namely: (1) “ [symbol] ,”, (2) “ [symbol] ;”, (3) “ [symbol] ,”, (4) “ [symbol] [symbol] ,”, (5) “ [symbol] ;”, (6) “ [symbol] [symbol] ,”, (7) “ [symbol] ,”.

In step 508, the terminal matches the n sentences sequentially in the revised electronic publication, similar to the step 406 (FIG. 4A).

Referring to FIG. 5B, in the illustrated embodiment, the sentences (3)-(6) are matched successfully, but the sentences 1-2 and 7 are not.

In step 510, if the earliest successfully matched sentence among the n sentences is not the 1st sentence, the terminal segments all the sentences, from the 1st sentence to a sentence immediately before the earliest successfully matched sentence, into m word segments arranged in order, and m is a positive integer. For example, each word segment can be a word.

Referring to FIG. 5B, the earliest successfully matched sentence in the step 508 is the 3rd sentence in the original character string, namely: “ [symbol] ,”. The terminal may segment the 1st and 2nd sentences into six word segments arranged in order: “ [symbol] ”, “ [symbol] [symbol] ”, “ [symbol] ”, “ [symbol] ”, “ [symbol] ”, “ [symbol] ”.

In step 512, from the start position of the earliest successfully matched sentence, the terminal matches the m word segments in a reverse order. After completing the matching of all the m word segments, the terminal sets the start position of the last successfully matched word segment as a start position of the original character string in the revised electronic publication.

Upon completion of matching all the m word segments, if the matching degree is within a first predetermined matching range, the terminal determines that the matching of the word segments is successful. The terminal sets the position of the last successfully matched word segment as a start position of the original character string in the revised electronic publication. If the matching degree is not within the first predetermined matching range, the terminal determines that the matching fails. The terminal sets the position of the first successfully-matched word segment as the original character string. The first predetermined matching degree may be, e.g., m1≧50% m, where m is the number of word segments obtained in step 510, and m1 represents the number of the successfully matched word segments.

Referring to FIG. 5B, the earliest successfully-matched sentence in step 508 is “ [symbol] [symbol] ”. The terminal sets “ [symbol] ” as the searching start position to match the six word segments obtained in step 510. The terminal does not find the word segment “ [symbol] ”. Thus, the matching of the word segment “ [symbol] ” fails. The terminal dose not update the searching start position and continues to take “ [symbol] ” as the searching start position to search the next word segment in a reverse order. Similar, the terminal fails to match “ [symbol] ” and “ [symbol] ”. But it successfully matches “ [symbol] ”. Thus, the terminal updates the searching start position as“ [symbol] ” and searches for “ [symbol] ” in a reverse order. The matching result is successful. The terminal then updates the searching start position as “ [symbol] ” and searches for the word segment “ [symbol] [symbol] ” in a reverse order. The matching result is a failure.

During the matching of the six word segments, not all the word segments are matched successfully, and therefore this is a partial matching. The terminal calculates the matching degree and the first predetermined matching range. Totally six word segments are matched, and only two word segments are matched successfully. 50% of the total number of matched word segments is 3, and 2<3, so the word-segmentation matching fails. The terminal does not update the start position of the original character string in the revised electronic publication. That is, the terminal still takes “ [symbol] ” as the start position of the original Chinese character string.

In the above example, if the number of the successfully matched word segments is greater than or equal to 3, the matching is successful. The terminal will update the start position of the original character string to be the position of the last successfully matched word segment.

In step 514, if the last successfully matched sentence among the n sentences is not the nth sentence, the terminal segments all the sentences, from a sentence immediately after the last successfully matched sentence to the nth sentence, into q word segments arranged in order, q being a positive integer.

Referring to FIG. 5B, the last successfully-matched sentence in the step 508 is the 6th sentence in the original character string, namely: “ [symbol] [symbol] ,”. The only sentence after the 6th sentence is “ [symbol] ,”. The terminal may segment this sentence into, e.g., three word segments: “ [symbol] ”, “ [symbol] ”, “ [symbol] ”.

In step 516, from the end position of the matched content of the last successfully matched sentence, the terminal sequentially matches the q word segments, and sets the end position of the last successfully matched word segment as the end position of the original character string in revised the electronic publication.

Upon completion of matching all the q word segments, if the matching degree is within a second predetermined matching range, the terminal determines that the matching of the word segments is successful. The terminal takes the position of the last successfully matched word segment as an end position of the original character string in revised the electronic publication. If the matching degree is not within the second predetermined matching range, the terminal determines that the word-segmentation matching fails. The terminal takes the position of the last successfully matched sentence as the end position of the original character string. The second predetermined matching range may be, e.g., q1≧50% q, where q is the number of the word segments obtained in step 514, and q1 represents the number of the successfully matched word segments.

Referring to FIG. 5B, the last sentence successfully matched by the terminal is “ [symbol] [symbol] [symbol] ,”. The terminal takes the end position “,” as the searching start position, and searches for the first word segment “ [symbol] ” in the contents after “,” until reaching the end of the chapter “.”. But the terminal does not find “ [symbol] ”. Thus, the matching of the word segment “ [symbol] ” fails. The terminal dose not update the searching start position and continues to take “,” as the searching start position to sequentially search the second word segment “ [symbol] ” in the contents after “,”. The terminal can find “ [symbol] ”. Thus, the matching of “ [symbol] ” is successful. The terminal then updates the searching start position as “ [symbol] ” and proceeds to match “ [symbol] ”. The matching is successful.

During matching of the three word segments, a part of the word segments is not matched successfully, and therefore this belongs to the partial matching. Since only a part of the three word segments are matched successfully, the terminal calculates the matching degree and compare it with the second predetermined matching range. Totally three word segments are matched, while two of them are matched successfully. 50% of the number of matched word segments is 1.5, and 2>1.5, so the terminal determines the word-segmentation matching as successful. The terminal sets the end position of “ [symbol] ” as the corresponding end position of the original character string in the revised electronic publication.

In the above example, if the number of the successfully-matched word segmentations is smaller than 1.5, the word-segmentation matching fails. Under such condition, the terminal does not update the end position of the original character string in the revised electronic publication. That is, the terminal keeps “,” as the end position of the original character string.

In step 518, the terminal calculates the matching degree of the original character string in the revised publication and compares it with a predetermined matching range. When the matching degree is within the predetermined matching range, the terminal determines that the matching is successful.

Similar to the step 406 (FIG. 4A), a third predetermined matching range may be expressed by the formula, e.g., 80% Len1≦Len2≦120% Len1, where Len1 is the length of the original character string, and Len2 is the length of the matched character string.

Referring to FIG. 5B, the original Chinese character string is “ [symbol] , [symbol] [symbol] ; [symbol] , [symbol] , [symbol] ; [symbol] [symbol] , [symbol] ,”, and the matched Chinese character string is “ [symbol] , [symbol] , [symbol] ; [symbol] [symbol] [symbol] , [symbol] ,”. The length of the original Chinese character string is 47 and the length of the successfully matched Chinese character string is 34. Because 80% and 120% of the length of the original Chinese character string are 37.5 and 56.4, respectively, and 34<37.5<56.4, the terminal determines that the matching of the original character string fails.

In step 520, if the matching is successful, the terminal updates the quoted content in the user data according to the matching result to obtain the updated user data. The step 520 is similar to the above-described step 206 (FIG. 2), step 306 (FIG. 3A), and step 406 (FIG. 4A).

It shall be note that the above embodiments (FIGS. 2-5B) are described as being executed in a terminal. However, in other embodiments, the execution entity for updating the user data may also be a server, and the terminal may download the updated user data from the server.

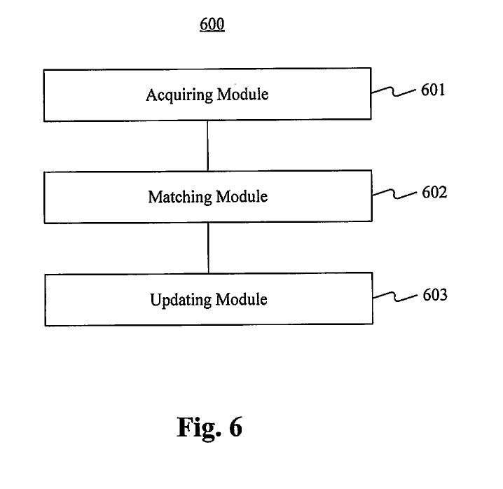

FIG. 6 is a block diagram of a device 600 for updating user data, according to an exemplary embodiment. The device 600 may include an acquiring module 601, a matching module 602 and an updating module 603.

The acquiring module 601 is configured to acquire an original character string, according to a quoted content in user data associated with an unrevised electronic publication. The acquiring module 601 is connected with the matching module 602.

The matching module 602 is configured to match the original character string in the revised electronic publication. The matching module 602 is connected with the updating module 603.

The updating module 603 is configured to update the quoted content in the user data according to the matching result when the matching is successful, to obtain updated user data.

In one exemplary embodiment, the matching module 602 is further configured to directly match the original character string in the revised electronic publication.

In one exemplary embodiment, the matching module 602 is further configured to segment the original character string into n sentences arranged in order, n being a positive integer and sequentially match the n sentences in the revised electronic publication.

In one exemplary embodiment, the matching module 602 is configured to directly match the original character string in the revised electronic publication; when the matching is not successful, segment the original character string into n sentences arranged in order, n being a positive integer and sequentially match the n sentences in the revised.

In exemplary embodiments, the matching module 602 may further includes a matching unit, a position updating unit, a continued matching unit, and a determining unit (not shown).

The matching unit is configured to match an ith sentence from a searching start position, where 1≦i≦n. When i=1, the searching start position is a start position of a chapter where the original character string is matched

The position updating unit is configured to, when the matching of the ith sentence is successful, update the searching start position to be an end position of the ith sentence so that the matching unit can match the (i+1)th sentence from the updated searching start position, where i+1≦n.

The continued matching unit is configured to, when the matching of the ith sentence is not successful, match the (i+1)th sentence from a searching start position corresponding to the ith sentence.

The determining unit is configured to, after completion of matching of all the n sentences, determine that the matching of the original character string is successful if the n sentences have a matching degree within a predetermined matching range.

In exemplary embodiments, the device 600 may further include a first word segmentation unit, a first word segmentation matching unit, and a start determining unit (not shown).

The first word segmentation unit is configured to, if the earliest successfully matched sentence among the n sentences is not the 1st sentence, segment all the sentences from the 1st sentence to a sentence immediately before the earliest successfully matched sentence into m word segments arranged in order, m being a positive integer.

The first word segmentation matching unit is configured to match the m word segmentations in a reverse order from a start position of a matched content of the earliest successfully matched sentence.

The start determining unit is configured to set a start position of the last successfully matched word segmentation as a start position of the original character string in the revised electronic publication.

In exemplary embodiments, the device 600 may further includes a second word segmentation unit, a second word segmentation matching unit, and an end determining unit (not shown).

The second word segmentation unit is configured to, if the last successfully matched sentence among the n sentences is not the nth sentence, segment all the sentences from a sentence immediately after the last successfully matched sentence to the nth sentence into q word segments arranged in order, q being a positive integer.

The second word segmentation matching unit is configured to sequentially match the q word segments from an end position of the last successfully matched sentence.

The end determining unit is configured to set an end position of a matched content of the last successfully matched word segmentation as an end position of the original character string in the revised electronic publication.

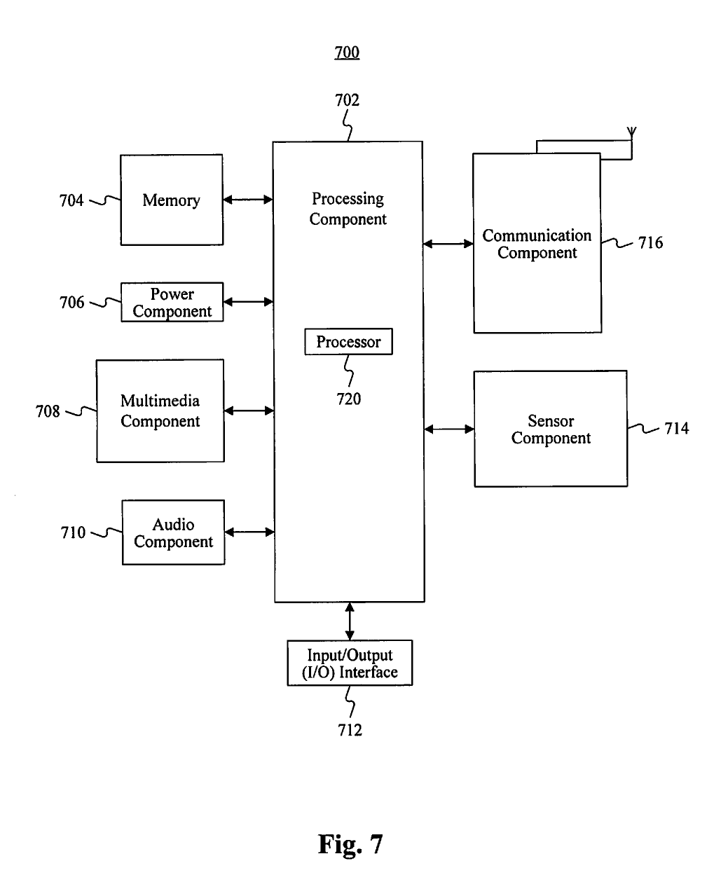

FIG. 7 is a block diagram of a device 700 for updating user data, according to an exemplary embodiment. For example, the device 700 may be a mobile phone, a computer, a digital broadcast terminal, a messaging device, a gaming console, a tablet, a medical device, exercise equipment, a personal digital assistant, and the like.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the device 700, such as the operations associated with display, telephone calls, data communications, camera operations, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the device 700 is in an operation mode, such as a photographing mode or a video mode. Each of the front camera and the rear camera may be a fixed optical lens system or may have focus and optical zoom capability.

The audio component 710 is configured to output and/or input audio signals. For example, the audio component 710 includes a microphone configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may detect open/closed statuses of the device 700, and relative positioning of components, such as the display and the keypad. The sensor component 714 may also detect position changes of the device 700 or its components, presence or absence of user contacts with the device 700, orientation or acceleration/deceleration of the device 700, and temperature changes of the device 700. The sensor component 714 may further include a proximity sensor configured to detect the presence of nearby objects without any physical contact. Moreover, the sensor component 714 may include a light sensor, such as a CMOS or CCD image sensor, for use in imaging applications. In some embodiments, the sensor component 714 may also include an acceleration sensor, a gyroscope sensor, a magnetic sensor, a pressure sensor, or a temperature sensor.

The communication component 716 is configured to facilitate wired or wireless communication between the device 700 and other devices. The device 700 can access a wireless network based on a communication standard, such as WiFi, 2G, 3G, or a combination thereof. In one exemplary embodiment, the communication component 716 receives a broadcast signal or broadcast related information from an external broadcast management system via a broadcast channel. In another exemplary embodiment, the communication component 716 further includes a near-field communication (NFC) module to facilitate short-range communications. The NFC module, for example, may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium storing instructions, such as stored in the memory 704, executable by the processor 720 in the device 700, for performing the above-described methods. For example, the non-transitory computer-readable storage medium may be a ROM, a random access memory (RAM), a CD-ROM, a magnetic tape, a floppy disc, an optical data storage device, and the like.

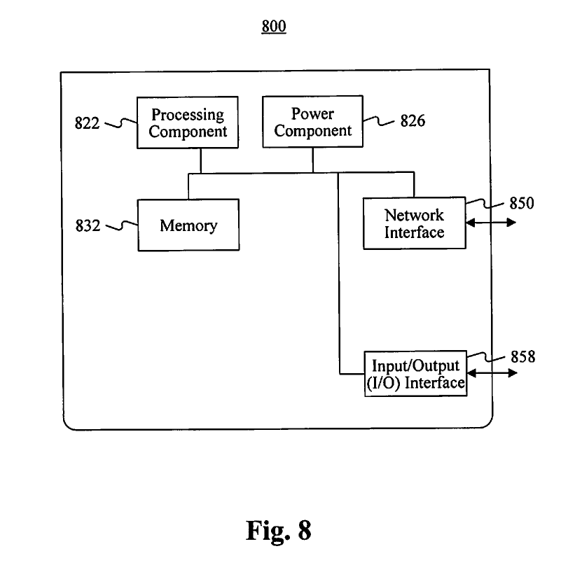

FIG. 8 is a block diagram of a device 800 for updating user data, according to an exemplary embodiment. For example, the device 800 may be provided as a server. Referring to FIG. 8, the device 800 includes a processing component 822 that further includes one or more processors, and memory resources represented by a memory 832 for storing instructions executable by the processing component 822, such as application programs. The application programs stored in the memory 832 may include one or more modules each corresponding to a set of instructions. Further, the processing component 822 is configured to execute the instructions to perform the above described methods for updating user data.

The device 800 may also include a power component 826 configured to perform power management of the device 800, wired or wireless network interface(s) 850 configured to connect the device 800 to a network, and an I/O interface 858. The device 800 may operate based on an operating system stored in the memory 832, such as Windows Server™, Mac OS X™, Unix™, Linux™, FreeBSD™, and the like.

In exemplary embodiments, there is also provided a non-transitory computer-readable storage medium storing instructions, such as stored in the memory 832, executable by the processor 822 in the device 800, for performing the above-described methods. For example, the non-transitory computer-readable storage medium may be a ROM, RAM, a CD-ROM, a magnetic tape, a floppy disc, an optical data storage device, and the like.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for updating user data after an electronic publication is revised, comprising:
acquiring, in the electronic publication before the revision, an original character string, according to a quoted content in user data associated with the electronic publication before the revision;
matching the original character string in the revised electronic publication; and
when the matching is successful, updating the quoted content in the user data according to the matching result, to obtain updated user data.

2. The method according to claim 1, wherein the matching of the original character string in the revised electronic publication comprises:
directly matching the original character string in the revised electronic publication.

3. The method according to claim 1, wherein the matching of the original character string in the revised electronic publication comprises:
segmenting the original character string into a plurality of segments arranged in order; and
sequentially matching the plurality of segments in the revised electronic publication.

4. The method according to claim 1, wherein the matching of the original character string in the revised electronic publication comprises:
directly matching the original character string in the revised electronic publication;
when the direct matching is unsuccessful, segmenting the original character string into a plurality of segments arranged in order; and
sequentially matching the plurality of segments in the revised electronic publication.

5. The method according to claim 3, wherein the plurality of segments are n sentence segments, and the sequentially matching of the n sentence segments in the revised electronic publication comprises:
matching an ith sentence segment from a searching start position, wherein 1≦i≦n, and when i=1, the searching start position is a start position of a chapter where the original character string is matched;
when the matching of the ith sentence segment is successful, updating the searching start position to be an end position of the ith sentence segment, and matching the (i+1)th sentence segment from the updated searching start position, wherein i+1≦n;
when the matching of the ith sentence segment is unsuccessful, matching the (i+1)th sentence segment from the searching start position corresponding to the ith sentence segment; and
after completing the matching of all the n sentence segments, if the n sentence segments have a matching degree within a predetermined matching range, determining that the matching of the original character string is successful.

6. The method according to claim 5, further comprising:
if the earliest successfully matched sentence segment among the n sentence segments is not the 1st sentence segment, further segmenting all the sentence segments from the 1st sentence segment to a sentence segment immediately before the earliest successfully matched sentence segment into m word segments arranged in order, m being a positive integer;
matching the m word segments in a reverse order, from a start position of the earliest successfully matched sentence segment; and
setting a start position of the last successfully matched word segment as a start position of the original character string in the revised electronic publication.

7. The method according to claim 5, further comprising:
if the last successfully matched sentence segment among the n sentence segments is not the nth sentence segment, further segmenting all the sentence segments from a sentence segment immediately after the last successfully matched sentence segment to the nth sentence segment into q word segments arranged in order, q being a positive integer;
sequentially matching the q word segments, from an end position of the last successfully matched sentence segment; and
setting an end position of the last successfully matched word segment as an end position of the original character string in the revised electronic publication.

8. A device for updating user data after an electronic publication is revised, comprising:
a processor;
a memory for storing instructions executable by the processor;
wherein the processor is configured to:
acquire, in the electronic publication before the revision, an original character string, according to a quoted content in user data associated with the electronic publication before the revision;
match the original character string in the revised electronic publication; and
when the matching is successful, update the quoted content in the user data according to the matching result, to obtain updated user data.

9. The device according to claim 8, wherein the processor is further configured to:
directly match the original character string in the revised electronic publication.

10. The device according to claim 8, wherein the processor is further configured to:
segment the original character string into a plurality of segments arranged in order; and
sequentially match the plurality of segments in the revised electronic publication.

11. The device according to claim 8, wherein the processor is further configured to:
directly match the original character string in the revised electronic publication;
when the direct matching is unsuccessful, segment the original character string into a plurality of segments arranged in order; and
sequentially match the plurality of segments in the revised electronic publication.

12. The device according to claim 10, wherein the plurality of segments are n sentence segments, and the processor is further configured to:
match an ith sentence segment from a searching start position, wherein 1≦i≦n, and when i=1, the searching start position is a start position of a chapter where the original character string is matched;
when the matching of the ith sentence segment is successful, update the searching start position to be an end position of the ith sentence segment, and match the (i+1)th sentence segment from the updated searching start position, wherein i+1≦n;
when the matching of the ith sentence segment is not successful, match the (i+1)th sentence segment from the searching start position corresponding to the ith sentence segment; and
after completing the matching of all the n sentence segments, if the n sentence segments have a matching degree within a predetermined matching range, determine that the matching of the original character string is successful.

13. The device according to claim 12, wherein the processor is further configured to:
if the earliest successfully matched sentence segment among the n sentence segments is not the 1st sentence segment, further segment all the sentence segments from the 1st sentence segment to a sentence segment immediately before the earliest successfully matched sentence segment into in word segmentations arranged in order, m being a positive integer;
match the m word segments in reverse order, from a start position of the earliest successfully matched sentence segment; and
set a start position of the last successfully matched word segment as a start position of the original character string in the revised electronic publication.

14. The device according to claim 12, wherein the processor is further configured to:
if the last successfully matched sentence segment among the n sentence segments is not the nth sentence segment, further segment all the sentence segments from a sentence segment immediately after the last successfully matched sentence segment to the nth sentence segment into q word segments arranged in order, q being a positive integer;
sequentially match the q word segments, from an end position of the last successfully matched sentence segment; and
set an end position of the last successfully matched word segment as an end position of the original character string in the revised electronic publication.

15. A non-transitory computer-readable storage medium storing instructions that, when executed by a processor of a device, cause the device to perform a method for updating user data after an electronic publication is revised, the method comprising:
acquiring, in the electronic publication before the revision, an original character string, according to a quoted content in user data electronic publication before the revision;
matching the original character string in the revised electronic publication; and
when the matching is successful, updating the quoted content in the user data according to the matching result, to obtain updated user data.
